(19) United States
(12) Patent Application Publication
(10) Pub. No.: US 2012/0304506 A1
(43) Pub. Date: Dec. 6, 2012

(54) MOUNTING OF WEAR MEMBERS

(75) Inventors: Miguel Guimaraes, Mackay (AU); Bruce Lilley, Mackay (AU)

(73) Assignee: CQMS Pty Ltd., Mackay, Queensland (AU)

(21) Appl. No.: 13/514,874

(22) PCT Filed: Dec. 10, 2010
(86) PCT No.: PCT/AU2010/001678

§ 371 Date: Aug. 15, 2012

(30) Foreign Application Priority Data
Dec. 11, 2009 (AU) 2009906065
Jul. 14, 2010 (AU) 2010903142

(51) Int. Cl. E02F 9/28; F16B 2/04; B23P 11/00

(52) U.S. Cl. 37/453; 29/428; 37/455; 37/456; 37/452; 403/374.4

(57) ABSTRACT

An excavator tooth assembly comprises a first wear member and a second wear member. The second wear member is releasably mountable on the first wear member. The first wear member has a lock face. The second wear member also has a lock face. The lock face of the first wear member opposes the lock face of the second wear to define a lock passage therebetween when the second wear member is mounted on the first wear member. The excavator tooth assembly includes a lock pin which is adapted to be received in the lock passage to releasably secure the second wear member to the first wear member.

### FIELD OF THE INVENTION

This invention is concerned with mounting of wear members of an excavator tooth assembly for earth excavating devices.

The invention is concerned particularly, although not exclusively, with the mounting of digging teeth to adaptors of an excavator bucket. It may also concern the mounting of an adaptor body to an adaptor nose of an excavator bucket or mounting of a tooth directly to a nose of an excavator bucket lip.

### BACKGROUND OF THE INVENTION

Excavator tooth assemblies mounted on the lip of excavator buckets and the like generally comprise wear members in the form of a replaceable digging tooth or point, and an adaptor which is secured by welding or the like to the lip of a bucket or the like. The adaptor may in some instance comprise an adaptor body and an adaptor nose welded to the lip. The adaptor body has a socket-like recess at its rear end to receivably locate a spigot portion of the adaptor nose. The digging tooth is mounted on the front end of the adaptor body.

In use, excavator teeth are subjected to extensive load forces along a longitudinal axis of a tooth as well as in vertical and transverse directions. A strong mount is required between the digging tooth and the front portion of the adaptor. The wear members are locked to each other by retaining pins. As the various components wear, the retaining pins can loosen thereby increasing the risk of loss of a digging tooth or an entire excavator tooth assembly.

The greatest loads experienced by digging teeth are vertical loads which tend to generate large moment forces capable of rotating a tooth off the front of an adaptor and/or rotating the adaptor/adaptor nose off the lip.

Despite many prior art attempts to improve the mounting of a tooth to an adaptor and an adaptor to a lip, most of these proposals suffer from one or more deficiencies.

U.S. Pat. No. 4,182,058 describes an excavator tooth having a rearwardly divergent tapering socket to receive a nose having a complementary-shaped front spigot portion. Resistance to rotational moment forces is borne by a resilient steel cotter pin extending through aligned vertical apertures in the socket and spigot portions.

U.S. Pat. No. 3,023,521 also describes an excavator tooth having a rearwardly divergent tapering socket to receive a complementary-shaped tooth support spigot portion. Rotational moment forces are resisted by a lip engaging in a recess in the tooth support member.

U.S. Pat. Nos. 3,774,324, 4,338,736, 4,481,728 and 4,903,420 all describe nose and tooth combinations wherein the nose has a generally convergently tapering spigot portion with a forward tip having a box-like configuration with at least the upper and lower surfaces thereof having faces parallel to each other and to a longitudinal axis of the nose portion. With the exception of U.S. Pat. No 4,338,736, which describes a transverse lock pin, each of the tooth mounting arrangements is heavily reliant on a large vertical lock pin to resist rotational moment forces tending to rotate the teeth off respective noses.

U.S. Pat. No. 4,231,173 describes a tapered adaptor nose having a box-like free end, which engages in a mating box-like socket cavity to resist rotational moments. Opposed pairs of rearwardly extending keys engage in corresponding recesses in the outer surfaces of the adaptor nose to resist rotational movements. Because the keys themselves are unsupported, they possess a limited capacity to resist rotational moment forces.

U.S. Pat. No. 5,272,824 describes a structure similar to that of U.S. Pat. No. 4,231,173 except that the side keys are of more robust dimensions and the upper and lower keys are formed as box-like members with apertures to receive a vertical mounting pin passing through aligned apertures in the tooth and adaptor nose.

U.S. Pat. Nos. 3,196,956 and 4,404,760 provide flat rail surfaces on the adaptor nose to engage with mating grooves in the socket aperture of a corresponding tooth. In the case of U.S. Pat. No. 3,196,956, the mating rail and groove surfaces are forwardly tapered, whereas in U.S. Pat. No. 4,404,760 the mating rail and groove surfaces are generally parallel to the longitudinal axis of a tooth.

U.S. Pat. No. 5,423,138 describes a generally tapered nose having a box-like front end with upper and lower transverse surfaces generally parallel to a longitudinal axis of a tooth. The parallel upper and lower transverse surfaces are contiguous with upper and lower rail surfaces on each side of the nose and parallel to the longitudinal axis of the tooth. A pair of rearwardly extending side keys locate in recesses formed in the outer side faces of the nose, ostensibly to resist rotational moment forces in the tooth. Because the side keys are recessed to accommodate the side rail portions, the robustness of the side keys is somewhat compromised.

U.S. Pat. No. 4,233,761 describes a fairly stubby tapered nose having a box-like front portion with upper and lower surfaces generally parallel to a longitudinal axis of an excavator tooth, an intermediate rearwardly diverging tapered portion and a rear portion having upper and lower surfaces extending generally parallel to a longitudinal axis of the tooth. Formed on the upper and lower surfaces of the front, intermediate and rear portions of the nose are spaced parallel reinforcing ribs which are located in mating grooves in the excavator tooth. A large vertical lock pin extends through aligned apertures in the tooth and nose between the reinforcing ribs. This structure is heavily reliant on the lock pin to resist rotational moment forces however it is considered that this configuration may be prone to failure in the rear portion of the adaptor.

U.S. Pat. No. 5,709,043 describes a nose/adaptor combination wherein the adaptor socket tapers convergently towards a box-like front portion having upper and lower bearing surfaces generally parallel to a longitudinal axis of the tooth, a front transverse upright bearing surface and rearwardly divergent bearing surfaces formed at obtuse angles between the converging upper and lower walls and the side walls of the socket, ostensibly to avoid areas of stress concentration.

U.S. Pat. No. 6,018,896 describes a pin/retainer system for locking an excavation tooth onto an adaptor wherein the retainer is inserted in the adaptor and a wedge-shaped pin is driven into aligned apertures in the tooth and adaptor to resiliently engage with the retainer.

United States Publication No US 2002/0000053A1 describes a mechanism for releasably retaining an adaptor into the nose of a bucket lip or the like wherein a tapered threaded socket is non-rotatably located on the inside of an aperture in the side wall of the adaptor. A threaded retaining pin extends through the threaded socket and locates in an aligned aperture in the bucket nose.

U.S. Pat. No. 5,337,495 describes a tooth point slidably locatable over a tapered adaptor front portion, the tooth point being releasably secured on the adaptor by a pair of cap screws extending through apertures in the side walls of the tooth into threaded inserts located in recesses on opposite sides of the adaptor front portion. The inserts have a shouldered face and a curved face nestable in complementary-shaped adaptor recesses to prevent rotation when the cap screws are threadably located therein.

U.S. Pat. No. 5,172,501 described attachment of a digging point to an adaptor by a threaded bolt extending through an aperture in a point for threaded engagement in a threaded opening in the adaptor. Other retention systems for digging points on adaptors or adaptors on noses are described in U.S. Pat. Nos. 6,119,378, 6,467,204, 6,052,927 and 6,467,203.

Other devices for removably securing replaceable wear elements on earth working equipment such as a retaining pin, a bolt, a pin lock, a spool and wedge system or a flex pin are described in U.S. Pat. Nos. 3,839,805, 3,982,339, 4,587,751 and 5,716,667 respectively.

U.S. Pat. No. 5,937,550 describes a lock assembly for releasably securing an adaptor to a nose of an excavator support structure. The lock assembly comprises a body and a base coupled together and adapted for insertion, while coupled together, in a hole in the nose of the support structure. The length of the lock assembly is extended to secure the adaptor and is retracted to release the adaptor. While adequate for securing an adaptor to a nose of an excavator support structure, the lock described in this patent is relatively complex in design and operation leading to high costs and labour intensive extraction procedures in the field.

Canadian Patent Application No 2,161,505 describes a system for removably retaining an excavation point on an adaptor with at least one flanged sleeve having a screw-threaded aperture therein, the flanged sleeve being non-rotatably locatable in a transverse bore in the adaptor before fitment of the point onto the adaptor. A screw-threaded pin is inserted into the sleeve via an aperture in the point whereby portion of the head of the pin retains the point on the adaptor.

While generally satisfactory for their intended purpose, the abovementioned prior art adaptor/tooth combinations all suffer from one or more shortcomings or disadvantages in terms of inadequate resistance to rotation of an tooth off an adaptor under the influence of vertical loads applying a rotational moment to the tooth, a predisposition to premature wear, difficulties in retention of tooth on the adaptors, inadequate locking systems and unduly complicated configurations giving rise to increased fabrication costs.

It is an aim of the present invention to overcome or alleviate at least some of the abovementioned prior art disadvantages or otherwise to provide consumers with a convenient choice.

### SUMMARY OF THE INVENTION

According to one aspect of the invention there is provided an excavator tooth assembly comprising:

a first wear member having a lock face;

a second wear member having a lock face, the second wear member releasably mountable to the first wear member;

wherein the lock face of the first wear member opposes the lock face of the second wear to define a lock passage therebetween when the second wear member is mounted on the first wear member.

According to another aspect of the invention there is provided an excavator digging tooth having a digging edge at a front end thereof, the digging tooth including:

a socket with a rearwardly facing socket opening;

spaced sidewalls having aligned apertures; and

a shoulder formation extending between the apertures.

According to yet another aspect of the invention there is provided an adaptor of an excavator tooth assembly, the adaptor comprising:

a mounting nose having:
a forwardly projecting spigot; and
a lock face located rearwardly of the spigot, the lock face outwardly open along a substantial length of the lock face.

Optionally, each adaptor may comprise an adaptor body and an adaptor nose.

According to still another aspect of the invention, there is provide a lock pin adapted to be received in a lock passage to releasably secure a first wear member to a second wear member, the lock pin comprising:
a lock body having an arm with a groove;
a wedge block having a key slideably received in the groove; and
a lock bolt rotatably captured in the lock body, the wedge block engaged by the lock bolt to displace the wedge block relative to the lock body as the lock bolt is rotated.

According to another aspect of the invention there is provided a method of relesably securing a second wear member of an excavator tooth assembly to a first wear member of the excavator tooth assembly, the method including:

mounting the second wear member to the first wear member so that a lock face of the first wear member opposes a lock face of the. second wear member to define a lock passage therebetween;

inserting a lock pin into the lock passage, thereby to releasably secure the second wear member to the first wear member.

### BRIEF DESCRIPTION OF THE DRAWINGS

In order that the invention may be more fully understood and put into practical effect, reference will now be made to the accompanying drawings in which:—

FIG. 1 shows a perspective view of a lip for an excavation device and a number of excavator tooth assemblies according to one aspect of the invention located on the lip;

FIG. 2A shows a perspective view of an adaptor of one of the excavator tooth assemblies of FIG. 1;

FIG. 2B shows another perspective view of the adaptor of FIG. 2A;

FIG. 2C shows a side view of the adaptor of FIG. 2A;

FIG. 3A shows a side view of a tooth of one of the excavator tooth assemblies of FIG. 1;

FIG. 3B shows a front perspective view of the tooth of FIG. 3A;

FIG. 3C shows a rear perspective view of the tooth of FIG. 3A;

FIG. 3D shows a front perspective view of the underside of the tooth of FIG. 3A;

FIG. 3E shows a sectional view of the underside of the tooth of FIG. 3A;

FIG. 3F shows another rear perspective view of the tooth of FIG. 3A;

FIG. 3G shows a side sectioned rear perspective view of the tooth of FIG. 3A;

FIG. 3H shows a side sectioned side perspective view of the tooth of FIG. 3A;

FIG. 4 shows an exploded perspective view of a lock pin of the one of the excavator tooth assemblies of FIG. 1;

FIG. 5A shows a perspective view of a lock body of the lock pin of FIG. 4;

FIG. 5B shows a reverse perspective view of the lock body of FIG. 5A;

FIG. 5C shows a side view of the lock body of FIG. 5A;

FIG. 5D shows a rear end view of the lock body of FIG. 5A;

FIG. 6 shows a perspective view of the lock body of FIG. 5A having keeper pins received in respective pairs of pin holes of the lock body;

FIG. 7A shows a perspective view from one end of the lock bolt of the lock pin of FIG. 4;

FIG. 7B shows a top view of the lock bolt of FIG. 7A;

FIG. 7C shows a perspective view from another end of the lock bolt of FIG. 7A;

FIG. 8 shows a perspective view of the lock bolt of FIG. 7A received in a bolt receiving channel of the lock body of FIG. 5A;

FIG. 9A shows a perspective view of a wedge block of the lock pin of FIG. 4 from an inner end of the wedge block;

FIG. 9B shows an end view of the wedge block of FIG. 9A from an outer end of the wedge block 302;

FIG. 9C shows a perspective view of the wedge block of FIG. 9A from the outer end of the wedge block;

FIG. 10 shows a perspective view of the lock pin of FIG. 4 in an assembled condition;

FIG. 11A shows a rear top perspective view of a wear cap of one of the excavator tooth assemblies of FIG. 1;

FIG. 11B shows a rear end perspective view of the wear cap of FIG. 11A;

FIG. 11C shows a rear bottom perspective view of the wear cap of FIG. 11A;

FIG. 12 shows a side perspective view of an excavator tooth assembly of FIG. 1 comprising the tooth of FIG. 3A mounted on the adaptor of FIG. 2A;

FIG. 13 shows another side perspective view of the excavator tooth assembly of FIG. 12;

FIG. 14 shows a side sectional view of the excavator tooth assembly of FIG. 12;

FIG. 14a shows a detailed sectional view of the lock passage formed by the excavator tooth assembly of FIG. 14;

FIG. 15 shows a perspective top sectional view of the excavator tooth assembly of FIG. 12 showing the lock passage of the excavator tooth assembly;

FIG. 16 shows the same perspective top sectional view of the excavator tooth assembly as FIG. 15, but with the lock pin of FIG. 10 received in the lock passage of the excavator tooth assembly;

FIG. 17 shows a side view of one of the excavator tooth assemblies of FIG. 1;

FIG. 18 shows an exploded perspective view a another embodiment of a lock pin of one of the excavator tooth assemblies of FIG. 1;

FIGS. 19 shows a perspective view of a lock body of the lock pin of FIG. 18;

FIG. 20 shows a perspective view of a lock bolt of the lock pin of FIG. 18;

FIG. 21 shows a sectional perspective view of the lock body of FIG. 19;

FIG. 22 shows a perspective view of the lock body of FIG. 19 having the lock bolt of FIG. 20 rotatably captured;

FIG. 23 shows a perspective view of a wedge block of the lock pin of FIG. 18 from an outer end of the wedge block;

FIG. 24 shows another perspective view of the wedge block of FIG. 23 from an inner end of the wedge block;

FIG. 25 shows another perspective view of the lock body of FIG. 19 having the lock bolt of FIG. 20 rotatably captured;

FIG. 26 shows a to sectional view of one of the lock pin in of FIG. 18 in an assembled condition;

FIG. 27 shows a top sectional view of one of the excavator tooth assemblies of FIG. 1, showing the lock pin of FIG. 18 mounted in a lock passage of the excavator tooth assembly; and

FIG. 28 shows the same top sectional view of the excavator tooth assemblies of FIG. 27, but with a wedge block of the lock pin of FIG. 18 spaced from the lock body of the lock pin mounted in the lock passage of the excavator tooth assembly.

### DETAILED DESCRIPTION OF THE DRAWINGS

In the accompanying drawings, for the sake of clarity, like reference numerals are employed for like features where appropriate.

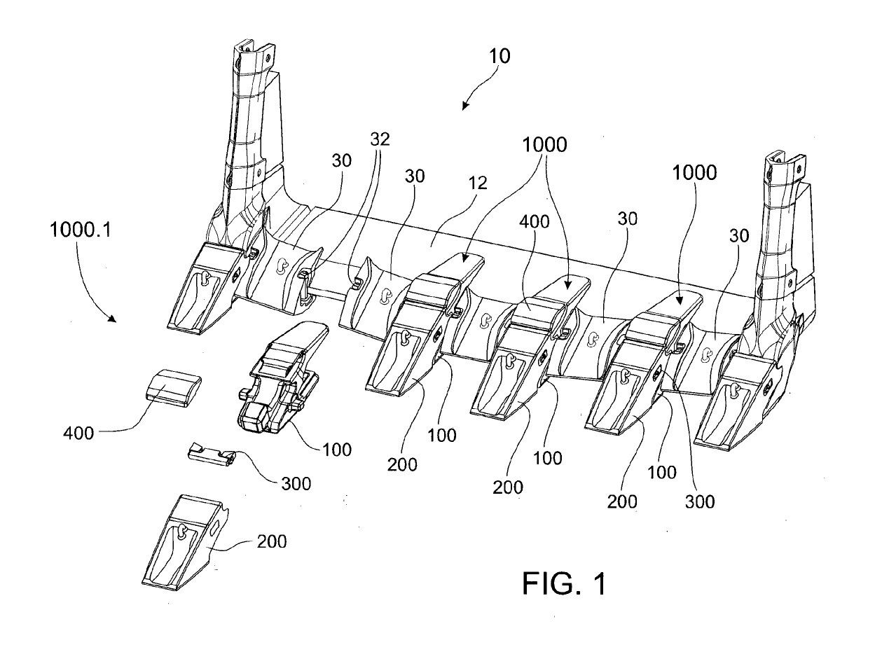

In FIG. 1 a wear assembly 10 for an excavation device such as an excavator bucket is shown. The wear assembly 10 includes a plate lip 12 having wear members attached thereto. The lip 12 has fixed thereto a number of excavator tooth assemblies 1000 and shrouds 30. The shrouds 30 are located between the tooth assemblies 1000. A skilled addressee will appreciate that the invention may be employed to releasably secure an adaptor nose to an adaptor body or a tooth directly to a nose of an excavator bucket lip.

One of the tooth assemblies 1000.1 is shown in exploded view comprising an adaptor 100, an excavator digging tooth 200, a lock pin 300 and a wear cap 400. The teeth 200 are mounted on the adaptors 100 and locked in place by the lock pins 300 in a secured condition of the tooth assemblies 1000. The wear caps 400 are fixed on top of the adaptors 100. The adaptors 100 are, in turn, welded to the lip 12. A skilled addressee will appreciate that the invention may be employed to releasably secure an adaptor nose to an adaptor body or a tooth directly to a nose of an excavator bucket lip.

The shrouds 30 are releasably mounted between the adaptors 100 by mounting pins 32. The shrouds 30 interlock with the adaptors 100.

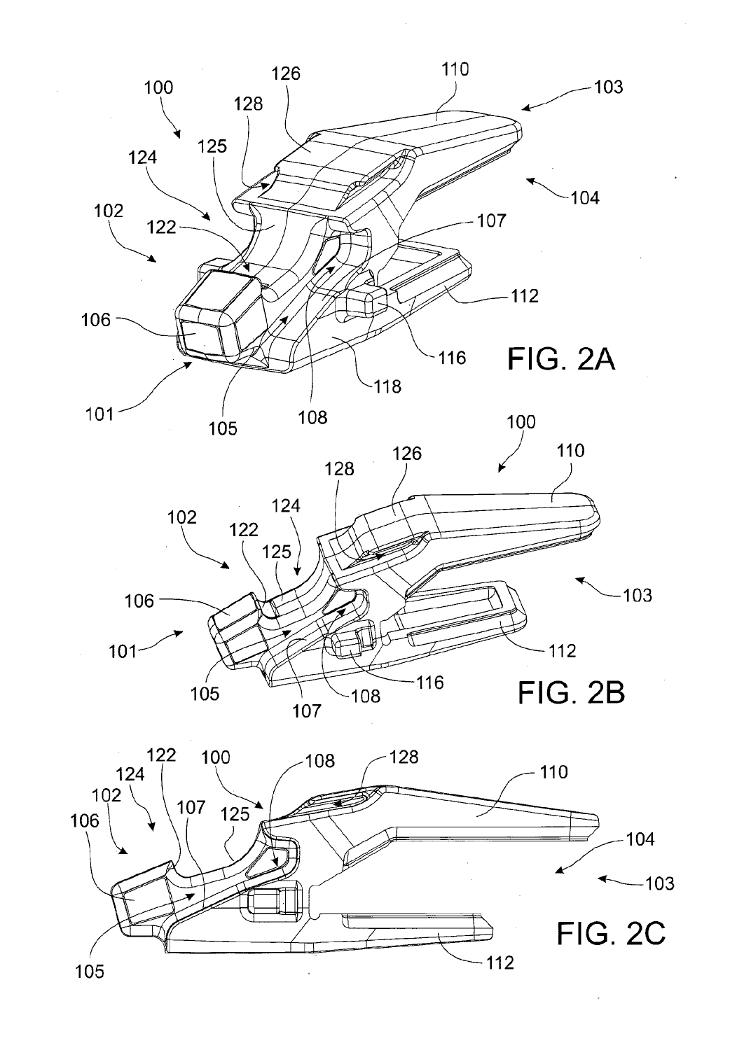

FIGS. 2A-2C show the adaptor 100. FIG. 2A and 2B, are respective front perspective views of the adaptor 100. FIG. 2C is a side view of the adaptor 100. The adaptor 100 comprises a forward facing mounting nose 102 at a front end 101 of the adaptor 100 and a rear jaw 104 at the rear end 103 of the adaptor 100. The mounting nose 102 has a spigot 106 shaped to be received in a socket 202 of the tooth 200.

The mounting nose 102 further includes channels 105 at opposite sides of the spigot 106. The channels 105 terminate at an ear receiving notch 108. The channels 105 have inclined bearing faces 107 which part of the tooth 200 bears against in the secured condition of the tooth assembly 100 as will be discussed in more detail.

The jaw 104 comprises an upper wall 110 and a lower wall 112 which are adapted to receive part of the lip 12 between them. The adaptor 100 is fixed to the lip 12 by welding the upper wall 110 and the lower wall 112 to the lip 12.

The adaptor 100 further comprises raised bosses 116 for interlocking with the shrouds 30. The bosses 116 stand proud of sides 118 of the adaptor 100.

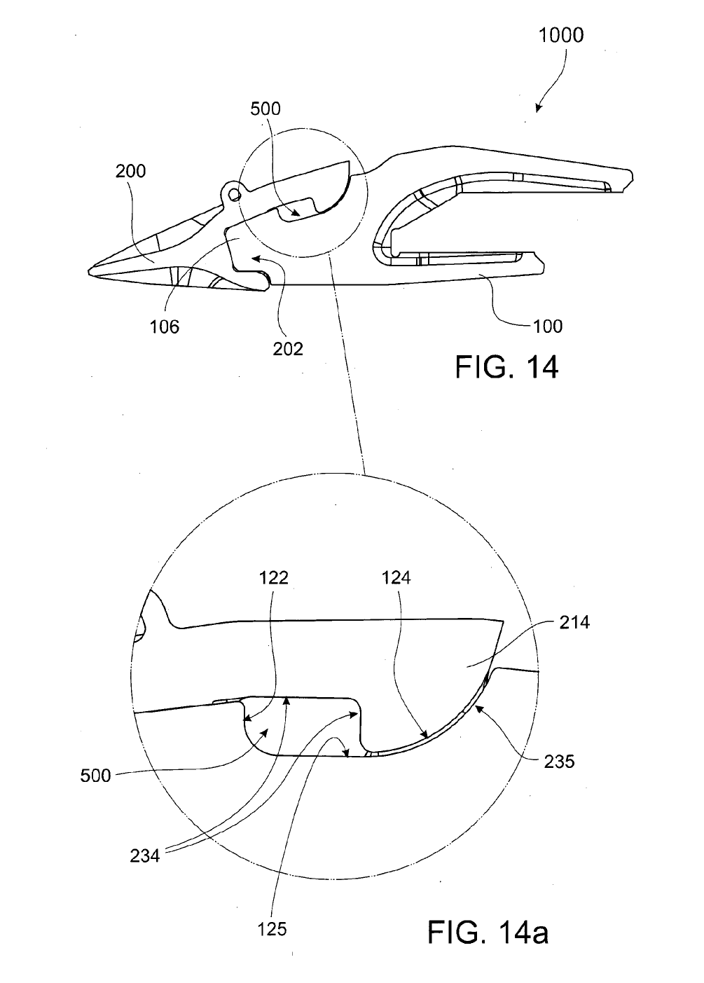

A lock bearing face 122 is located rearwardly of the spigot 106 of the nose 102. The lock bearing face 122 forms part of a larger saddle 124 having a lock face 125. The lock face 125 extends the length of the saddle 124. The length of the lock face is from the front end 101 of the adaptor 100 to the rear end 103 of the adaptor 100. The saddle 124 is generally concave. The lock face 125 defines part of a bore of a lock passage 500 as described with reference to FIG. 14.

The wear cap 400 is mounted on a cap mounting formation 126 at the top of the adaptor 100. Rails of the wear cap 400 slot into grooves 128 of the cap mounting formation 126. The wear cap 400 is captured in its position mounted on the cap mounting formation 126 by abutment against the tooth 200 when the tooth 200 is mounted on the adaptor 100. The wear cap 400 can be removed by removing the tooth 200 from the adaptor 100.

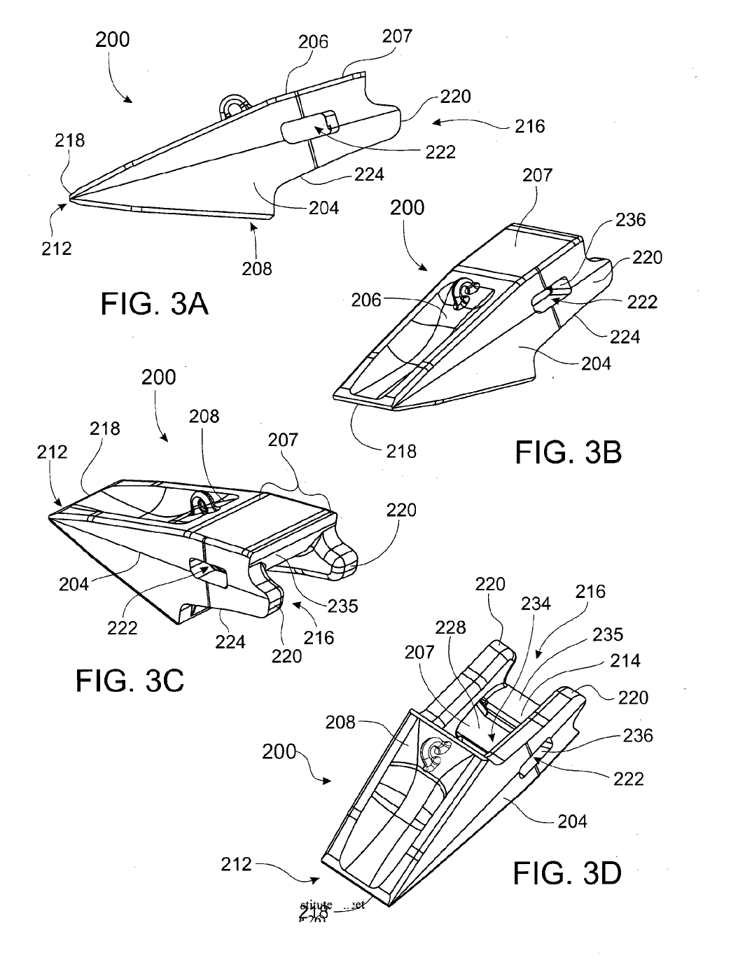

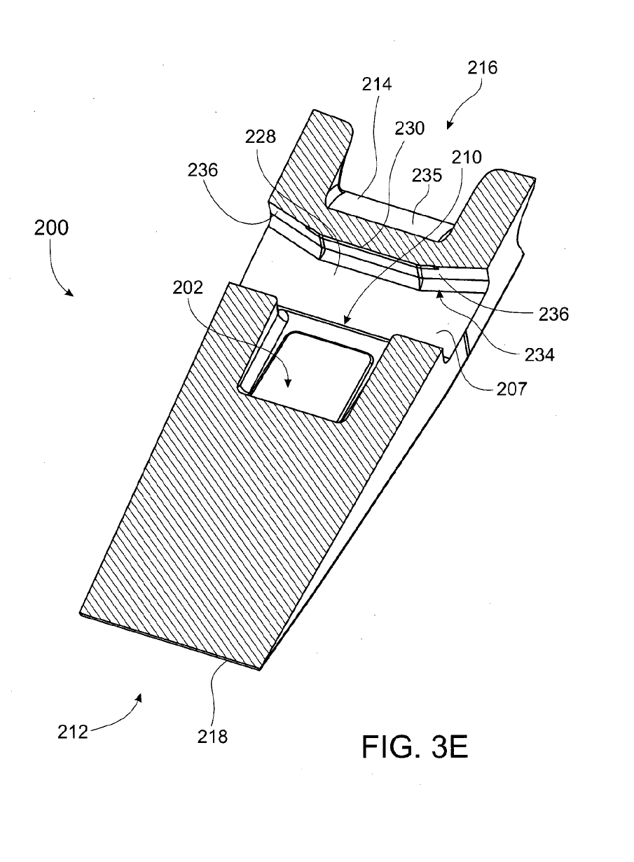

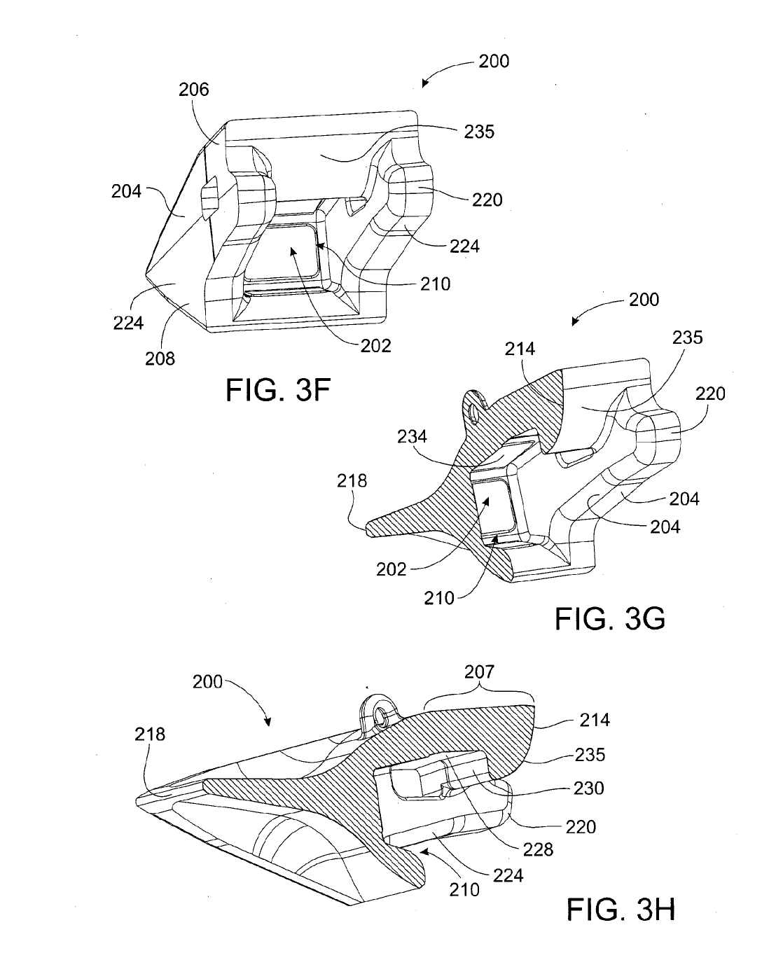

FIGS. 3A to 3H show one of the digging teeth 200 of FIG. 1. FIG. 3A shows a side view of the tooth 200. FIG. 3B shows a front perspective view of the tooth 200 and FIG. 3C shows a rear perspective view of the tooth 200. FIG. 3D shows a front perspective view of the underside of the tooth 200. FIG. 3E is a bottom sectional view of the digging tooth 200. FIG. 3F shows another rear perspective view of the digging tooth in which socket 202 of tooth 200 is visible. FIG. 3G is a sectional rear perspective view of the tooth 200 showing part of the socket 202. FIG. 3H is another sectional perspective view of the tooth 200.

The tooth 200 comprises spaced sidewalls 204 and upper and lower walls 206, 208 converging from a rearwardly facing socket opening 210 to a front end 212 of its socket 202. The tooth 200 has a digging edge 218 at a front end 212 thereof. The upper wall 206 extends past the socket opening 210 and includes a shoulder formation 214 at the rear end 216 of the tooth 200. The part of the upper wall 206 extending past the socket opening 210 forms a roof 207 of the tooth 200. The shoulder formation 214 extends operatively downwardly from the roof 207 at the rear end 216 of the tooth 200. The shoulder formation 214 is spaced from the socket opening 210 of the tooth 200.

A roof face 228 of the roof 207 extends between the socket opening 210 and the shoulder formation 214. The shoulder formation 214 has a forwardly facing shoulder face 230 which meets the roof face 228. The shoulder face 230 is operatively downwardly extending from the roof face 228. The roof face 228 and the shoulder face 230 together define a lock face 234 of the tooth 200.

The shoulder formation 214 further comprises a saddle abutment face 235 which curves inwardly from the top of the roof 207 to the shoulder face 230. The saddle abutment face 235 is configured to be complementary to part of the saddle 124 of the adaptor 100.

FIGS. 3F and 3G show the socket 202 of the tooth 200. The socket 202 is complementary-shaped to receive the spigot 106 of the adaptor 100.

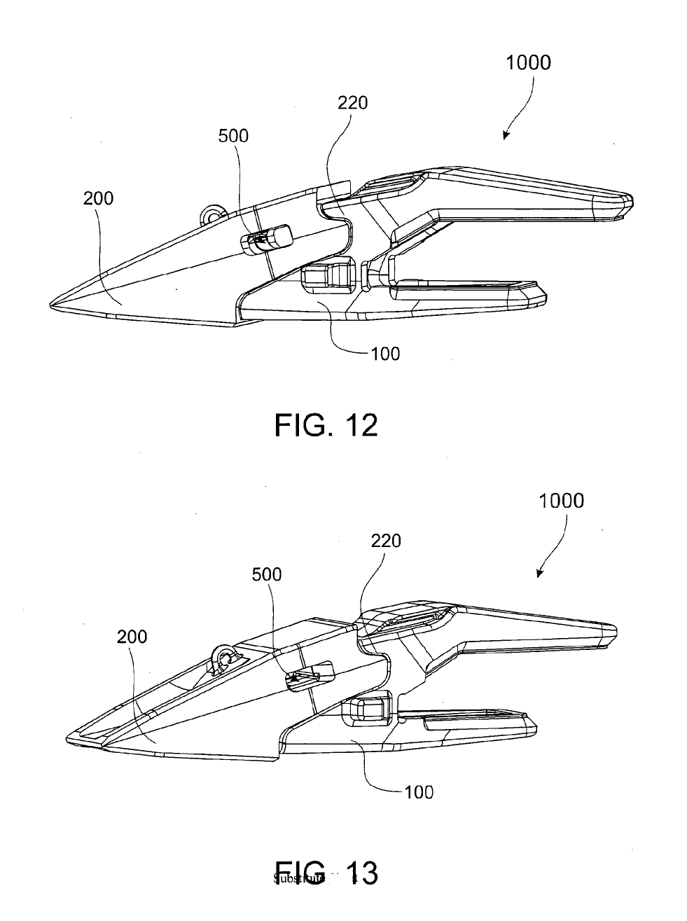

The sidewalls 204 include rearwardly projecting ears 220 which are complementary-shaped to be received in the notches 108 of the adaptor 100. Perspective views of the ears 220 of the tooth 200 received in a notch 108 of the adaptor 100 are shown in FIGS. 12 and 13. The ear 220 and notch 108 cooperate to prevent rotation of the tooth 200 about the adaptor 100. The tooth 200 is constrained from rotation off the front of the adaptor 100 while the ears 220 are seated in the notches 108.

The sidewalls 204 each have lower channel edges 224 which extends to the ears 220. The lower channel edges 224 of the sidewalls 204 are receivable in the channels 105 of the adaptor 100 in abutment with the inclined bearing faces 107 of the adaptor 100.

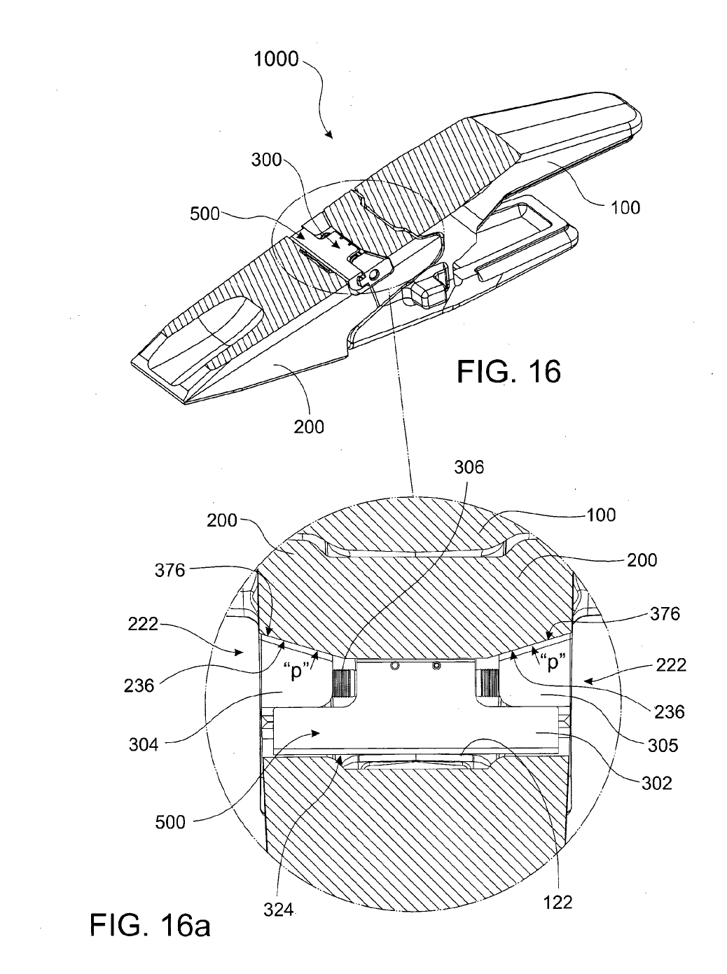

The tooth 200 includes aligned apertures 222 in the opposite side walls 204. The apertures 222 receive ends of the lock pin 300 therein when locking the tooth 200 to the adaptor 100. Referring to FIG. 3E, wedge bearing faces 236 of the tooth 200 angle rearwardly from the shoulder face 230 and extend into each of the apertures 222. The wedge bearing faces 236 are inclined relative to the shoulder face 230. The lock pin 300 engages the wedge bearing faces 236 to pull the tooth up onto the adaptor 100 in the secured condition of the tooth assemblies 1000 as described more particularly with reference to FIG. 16.

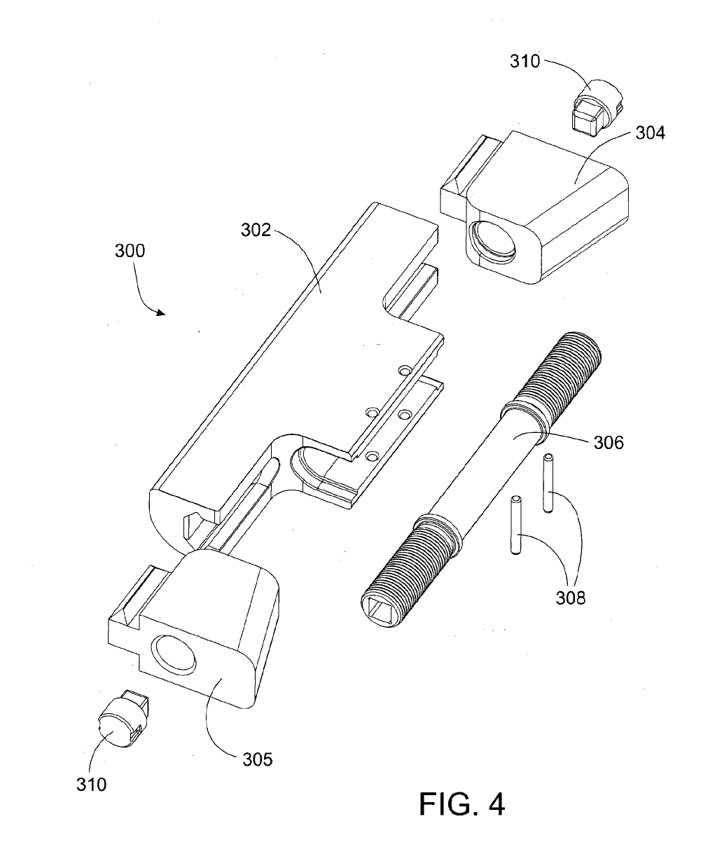

FIG. 4 shows an exploded perspective view of the lock pin 300. The lock pin 300 comprises a lock body 302, two opposite wedge blocks 304, 305, a lock bolt 306, two keeper pins 308 and plugs 310.

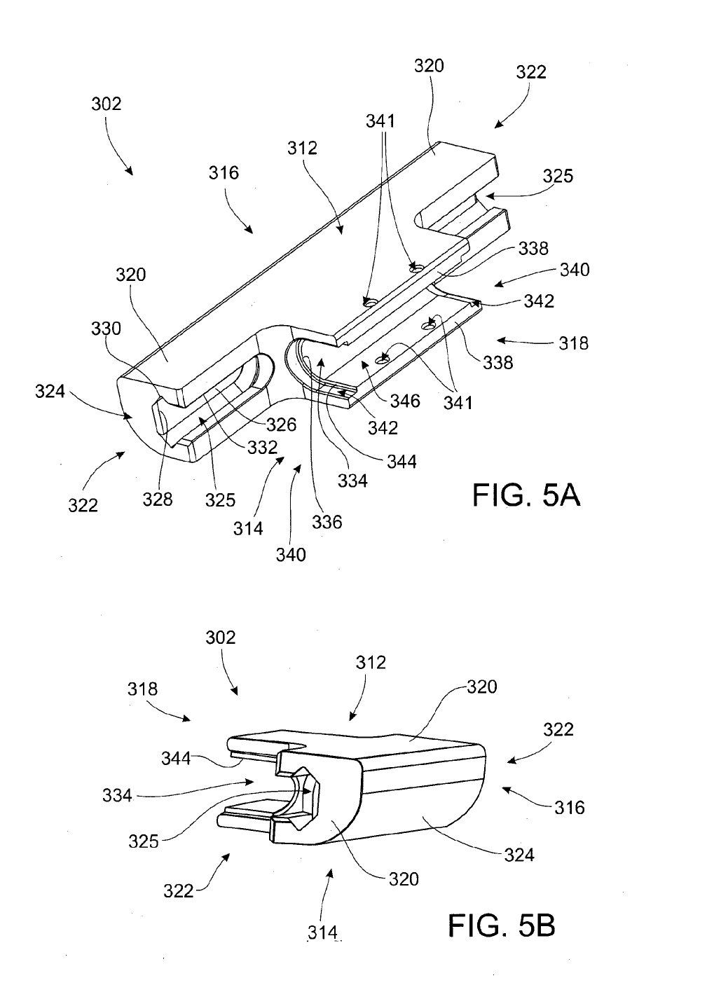

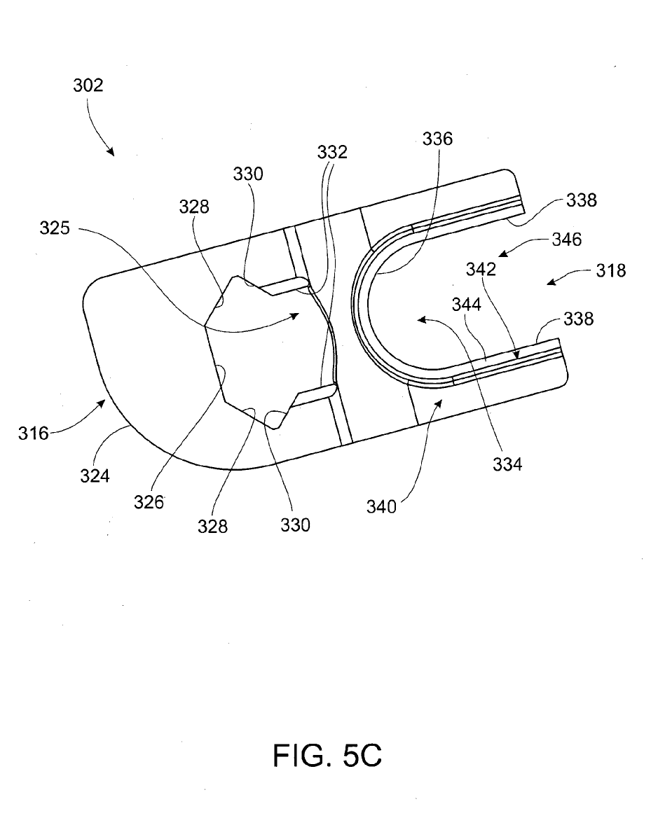

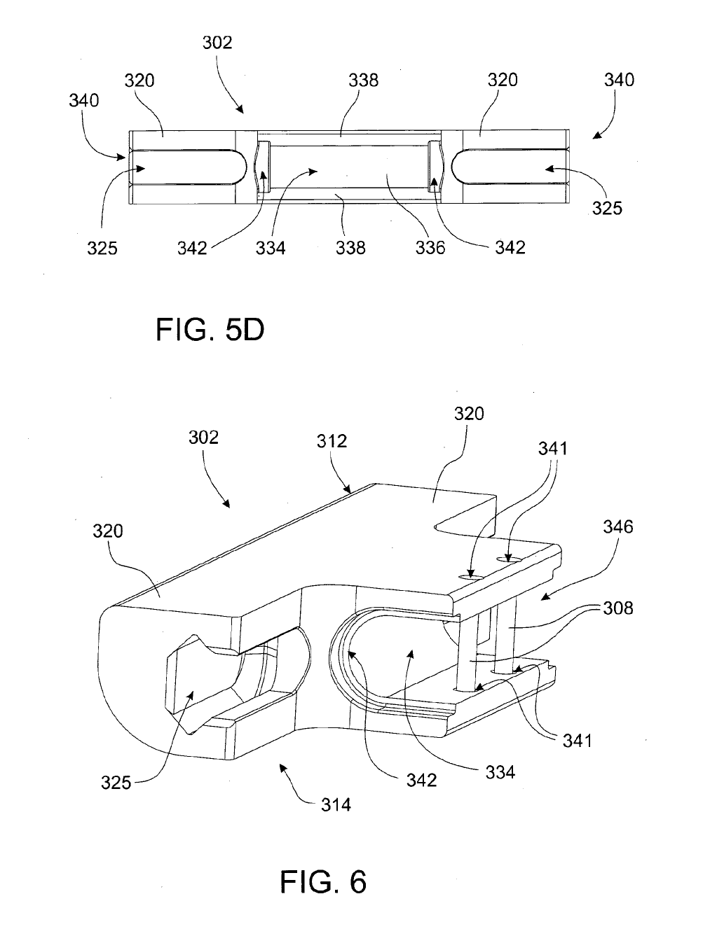

FIGS. 5 A-C show different views of the lock body 302. FIG. 5A is a perspective view of the lock body 302, FIG. 5B a reverse perspective view of the lock body 302, FIG. 5C is a side view of the lock body 302 and FIG. 5D is a rear end view of the lock body 302.

The lock body 302 has an upper side 312, an underside 314, a front end 316, a rear end 318 and opposite arms 320 having distal ends 322. A forward facing adaptor bearing face 324 extends between the distal ends 322 of the arms 320. The adaptor bearing face 324 is configured to engage and bear against the lock bearing face 122 of the adaptor 100. The adaptor bearing face 324 is curved from the upper side 312 to the lower side 314.

Each arm 320 has an undercut groove 325 formed therein. The grooves 325 extend longitudinally along the arms 320. Each groove 325 originates at a distal end 322, where the undercut profile of the grooves 325 can be seen end on as exemplified in FIG. 5C. Referring to FIG. 5C, the grooves 325 have a flat floor 326, sidewalls 328 which outwardly diverge from the floor 326, undercut walls 330 which are inwardly diverging from the sidewalls 328 and parallel walls 332.

The lock body 302 includes a bolt receiving channel 334 in which a shank part of the lock bolt 306 is captured. The channel 334 comprises a concave floor 336 and parallel sidewalls 338 projecting from the floor 336. The floor 336 is hemi-circular in profile. The channel 334 has opposite ends 340. Each end 340 has a recessed race 342 for receiving a collar of the lock bolt 306. Each race 342 has a shoulder 344 against which the collar of the lock bolt 306 abuts to constrain longitudinal displacement of the lock bolt 306 in the channel 334.

The channel 334 has an entrance 346 between the sidewalls 338, through which the lock bolt 306 is received in the channel 334. Two sets of aligned keeper pin holes 341 are located in the sidewalls 338 at a rearward edge region of the lock body 302. The pin holes 341 receive the keeper formations in the form of the keeper pins 308 for selectively obstructing the entrance to the channel 334.

FIG. 6 shows a perspective view of the lock *body 302 having the keeper pins 308 received in the respective pairs of pin holes 341. The keeper pins 308 obstruct the entrance 346 to the channel, thereby capturing the lock bolt 306 in the channel 334, in use.

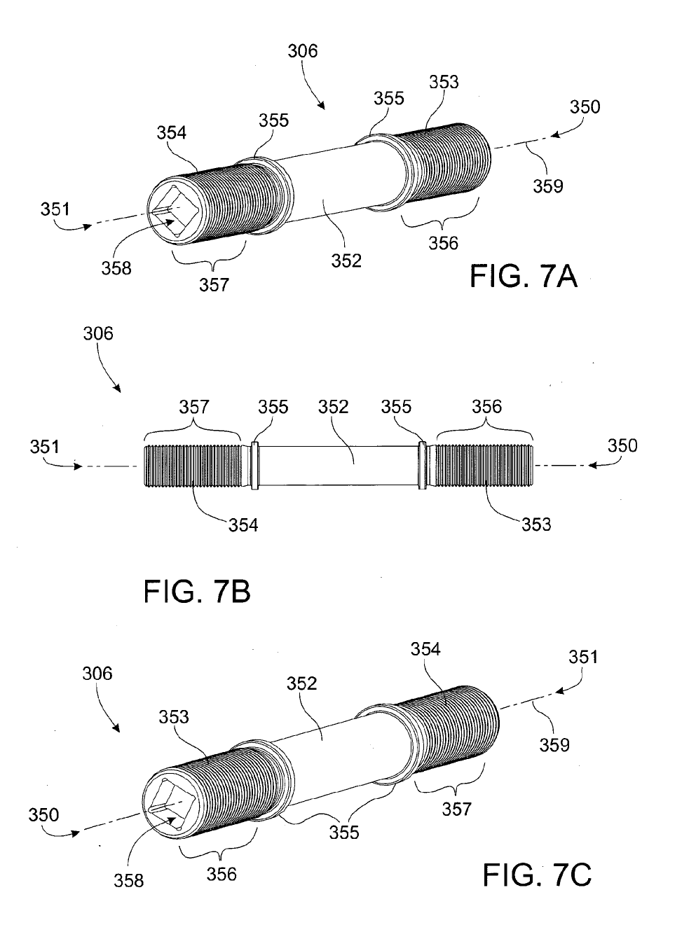

FIGS. 7 A-C show the lock bolt 306 in more detail. FIG. 7A is a perspective view from one end 351 of the lock bolt 306. FIG. 7B is a top view of the lock bolt 306 and FIG. 7C is a perspective view from another end 350 of the lock bolt 306. The lock bolt 306 is a generally cylindrical shaft having a rotational axis 359. The lock bolt 306 comprises a central shank 352, screw-threaded sections 353, 354 at both ends 350, 351 of the lock bolt 306, and collars 355 between the screw threaded sections 353, 354 and the central shank 352. The central shank 352 is relatively smooth and has a diameter so as to be receivable in the channel 334 of the lock body 302. The collars 355 are of larger diameter than the central shank 352 and dimensioned to be received in the races 342 on either side of the channel 334. The screw-threaded sections 353, 354 each have screw thread 356, 357 respectively. The screw threads 356, 357 are of different handedness. For example, if the screw thread 356 of the screw-threaded section 353 is a left hand thread then the screw thread 357 of the section 354 is right hand thread. The different handedness of the screw-threaded sections 356,357 provide for the wedge blocks 304, 305 to simultaneously move toward or away from each other as the case may be as the lock bolt 306 is rotated.

The lock bolt 306 has a square socket 358 at each end 350,351. The socket 358 is engageable by a driving tool to apply torque to the lock bolt 306 to rotate the lock bolt 306 about its rotational axis 359. The plugs 310 shown in FIG. 4 have square keys 311 to be received in the sockets 358 to locate the sockets 358 relative to the lock bolt 306.

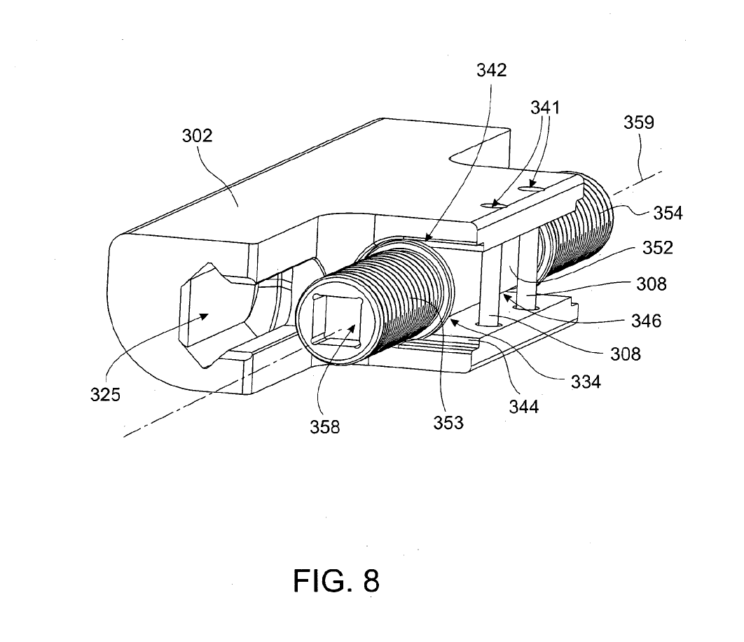

FIG. 8 shows a perspective view of the lock bolt 306 received in the bolt receiving channel 334 of the lock body 302. The collars 355 are located in the races 342 of the lock body 302. The central shank 352 is received in the bolt receiving channel 334. The keeper pins 308 prevent the lock bolt from being ejected through the entrance 346 to the bolt receiving channel 334. The collars 355 bear against the shoulders 344 of the races, in use, to constrain axial movement of the lock bolt 306 in a direction along the rotational axis 359.

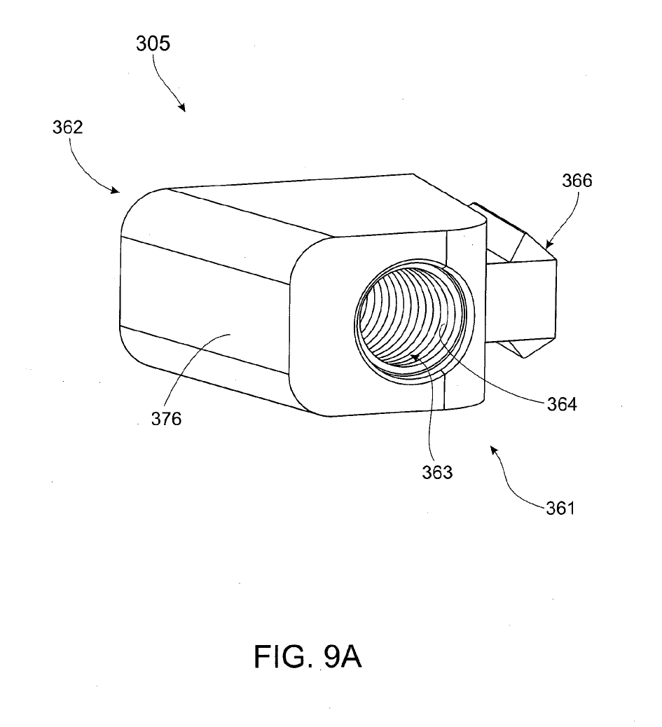

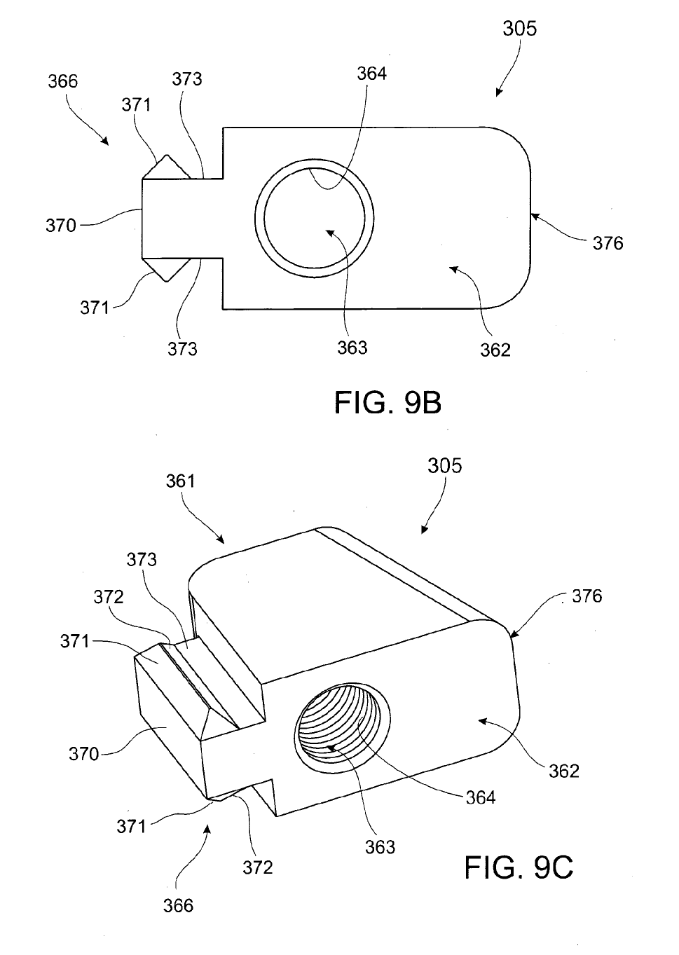

FIGS. 9A-C show one of the wedge blocks 305. The wedge block 304 is the same as the wedge block 305, with the only difference being the handedness of the internal screw thread in the different wedge blocks 304, 305 as discussed hereinbelow. FIG. 9A shows a perspective view of the wedge block 305 from an inner end 361 of the wedge block 305. FIG. 9B shows an end view of the wedge block 305 from an outer end 362 of the wedge block 302. FIG. 9C is a perspective view from the outer end 362 of the wedge block 305. A bore 363 extends from the inner end 361 of the wedge block 305 to the outer end 362 of the wedge block 305. The bore 363 has an internal screw-thread 364 for screw threadingly engaging the lock bolt 306. The screw-thread 364 of the different wedge blocks 304, 305 have different handedness so that each wedge block 304, 305 may screw-threadingly engage a different screw thread 353, 354 of the lock bolt 306.

The wedge block 305 has a key 366 which is receivable in the groove 325 of the lock body 302. The key 366 is complementary configured to the groove 325 to be slidably received in the groove 325. The key 366 has a floor face 370, sidewall faces 371 which outwardly diverge from the floor face 370, undercut faces 372 which inwardly diverge from the sidewall faces 371 and parallel faces 373. The floor face 370 is complementary to the flat floor 326 of the groove 325. The sidewall faces 371 are complementary to the sidewalls 328 of the groove 325. The undercut faces 372 are complementary to undercut walls 330 of the groove 325. The parallel faces 332 are complementary to the parallel walls 332 of the groove 325.

The wedge block 305 has an inwardly convergent tapered portion 376 at an opposite side of the wedge block 305 to the key 366. The tapered portion 376 bears against the wedge bearing faces 236 of the tooth 200 as will be described in more detail.

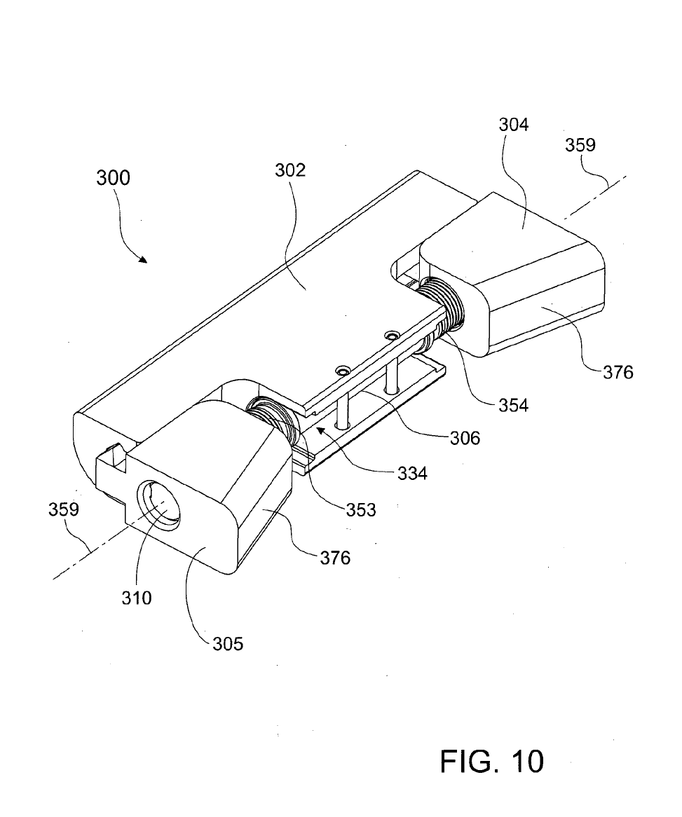

FIG. 10 shows a perspective view of the lock pin 300 in an assembled condition. The lock bolt 306 is captured in the bolt receiving channel 334 of the lock body 302 as described with reference to FIG. 8. The wedge block 305 is screw-threadingly received on screw-threaded sections 356 at one end 350 of the lock bolt 306. The other the wedge block 304 is screw-threadingly received on screw-threaded sections 357 at the other end 351 of the lock bolt 306. The keys 366 of the wedge blocks 304,305 are received in the grooves 325 of the lock body 302. The key-in-groove retention of the key 366 in the groove 325 allows for displacement of the wedge blocks 304, 305 along the rotational axis 359 of the lock bolt 306, but prevents dislocation of the wedge blocks 304, 305 from the lock body 302 in a direction normal to the rotational axis 359. The key-in-groove retention also prevents the wedge blocks 304, 305 from rotation relative to the lock body 302. When the lock bolt 306 is rotated, in use, the wedge blocks 304, 305 are urged either toward each other or away from each other, depending on the direction of rotation of the lock bolt 306.

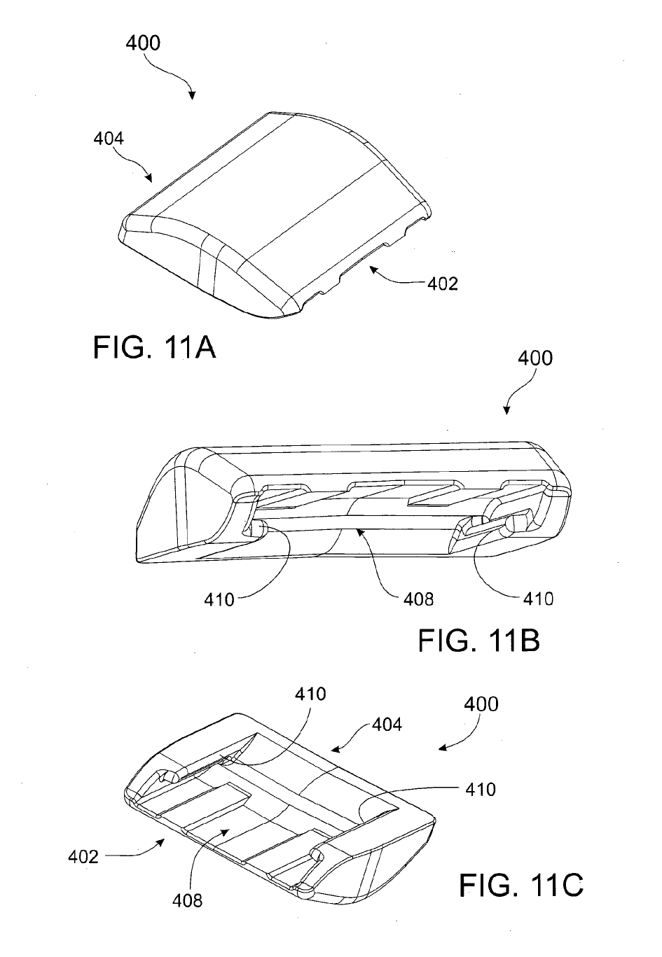

FIGS. 11A-C show different perspective views of the wear cap 400. FIG. 11A shows a rear top perspective view of the wear cap 400. FIG. 11 B show a rear end perspective view of the wear cap 400 and FIG. 11C shows a rear bottom perspective view of the wear cap 400.

The wear cap 400 has a front end 404 and a rear end 402. The wear cap has a cavity 408 in which the mounting formation 126 of the adaptor 100 is received. Rails 410 of the wear cap extend into the cavity 408. The rails 410 run from the rear end 404 to the front end 402. The rails 410 of the wear cap 400 are slidably receivable in the grooves 128 of the adaptor 100. In use, the wear cap 400 is slid onto the mounting formation 126 of the adaptor 100 rear end 402 first, with the rails 410 in the grooves 128. The wear cap 400 is locked in position on the adaptor 100 when the tooth 200 is mounted on the adaptor 100. The mounted tooth 200 abuts against the front end 404 of the wear cap 400, preventing it from sliding off the mounting formation 126 while the tooth 200 is mounted on the adaptor 100.

FIGS. 12 and 13 show different perspective views of an excavator tooth assembly comprising the tooth 200 mounted on the adaptor 100 so that a lock passage 500 is defined between the lock face 234 of the tooth 200 and the lock face 125 of the adaptor 100. The ears 220 of the tooth 200 are seated in the notches 108 of the adaptor 100 to constrain the tooth 200 from rotating relative to the adaptor 100. The lower channel edges 224 of the sidewalls 204 are located in the channels 105 of the adaptor 100 in abutment with the inclined bearing faces 107 of the adaptor 100.

FIG. 14 shows a sectional view of the tooth 200 mounted on the adaptor 100. The spigot 106 of the adaptor 100 is received in a socket 202 of the tooth 200. The saddle abutment face 235 of the shoulder formation 214 of the tooth 200 abuts against saddle 124 of the adaptor 100. The detail view of FIG. 14a shows the lock face 234 of the tooth 200 and the lock face 125 of the saddle 124 oppose each other to define the lock passage 500 between the lock face 125 and the lock face 234. The lock passage 500 is non-circular in cross section, which prevents the lock pin 300 from rotating in the lock passage 500.

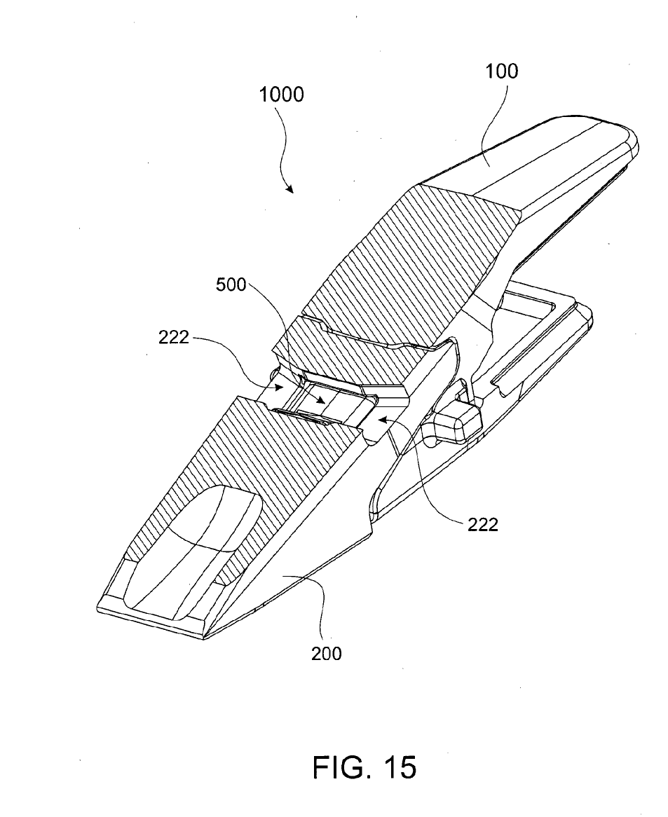

FIG. 15 shows a perspective top sectional view of the tooth assembly comprising the tooth 200 mounted on the adaptor 100. The apertures 222 of the tooth 200 are shown in register with the lock passage 500. FIG. 16 shows the same perspective top sectional view of FIG. 15, but with the lock pin 300 received in the passage 500. A detail view of the lock pin 300 in the passage 500 is shown in detail FIG. 16a. The wedge blocks 304, 305 of the lock pin are captured in the apertures 222. The tapered portions 376 of the wedges 304, 305 bear against the wedge bearing faces 236 of the tooth 200. The wedge blocks 304, 305 exert pull-on forces “P” on the wedge bearing faces 236 of the tooth 200. The adaptor bearing face 324 of the lock body 302 bears against the lock bearing face 122 of the adaptor 100 to counteract the pull-on forces “P”. The lock pin 300 is tightened by rotating the lock bolt in a direction so that the wedges 304, 305 are forced toward each other. As is readily apparent from FIG. 16a, tightening the lock pin 300 causes the wedge blocks 304, 305 to exert greater pull-on force “P” on the tooth 200, thereby pulling the tooth onto the adaptor 100. During operation the tooth 200 may loosen from its mount on the adaptor 100 due to vibration and digging forces. Periodic tightening of the lock pin 300 ensures a solid lock of the tooth 200 to the adaptor 100.

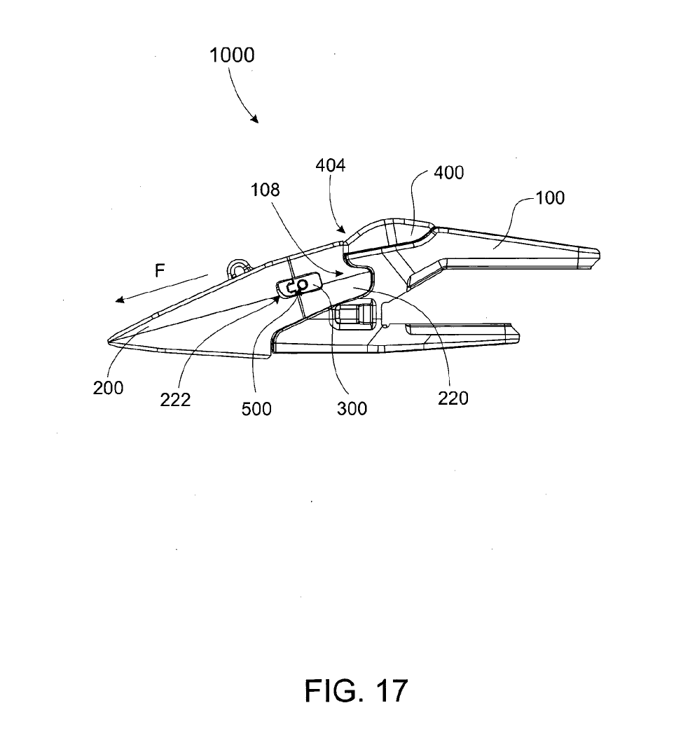

FIG. 17 shows a side view of the excavator tooth assembly 1000. The lock pin 300 received in the lock passage 500 with ends of the lock pin 300 captured in the apertures 222.

The lock pin 300 constrains the tooth 200 from sliding off the adaptor 100 in a forward direction “F”. The lock pin 300 keeps the ears 220 seated in the notches 108 by preventing displacement of the tooth 200 relative to the adaptor 100 in the forward direction “F”. The lock pin 300 pulls the tooth 200 onto the adaptor 100 as already described with reference to FIG. 16.

FIG. 17 also shows the wear cap 400 is mounted on the adaptor 100. The tooth 200 abuts against a front end 404 of the wear cap 400 to capture the wear cap 400 in its location mounted on the adaptor 100.

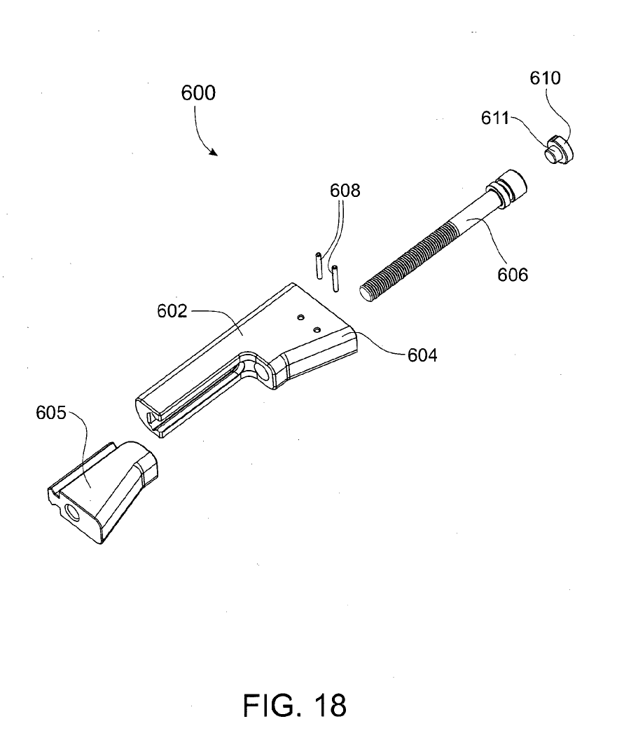

FIG. 18 shows an exploded perspective view a lock pin 600 in accordance with another embodiment of the invention. The lock pin 600 comprises a lock body 602, a wedge block 605, a lock bolt 606, two keeper pins 608 and a plug 610. The lock pin 600 has various features which are the same or similar to features of the lock pin 300. Selected features of the lock pin 600 are described as the same as features of the lock pin 300 for conciseness.

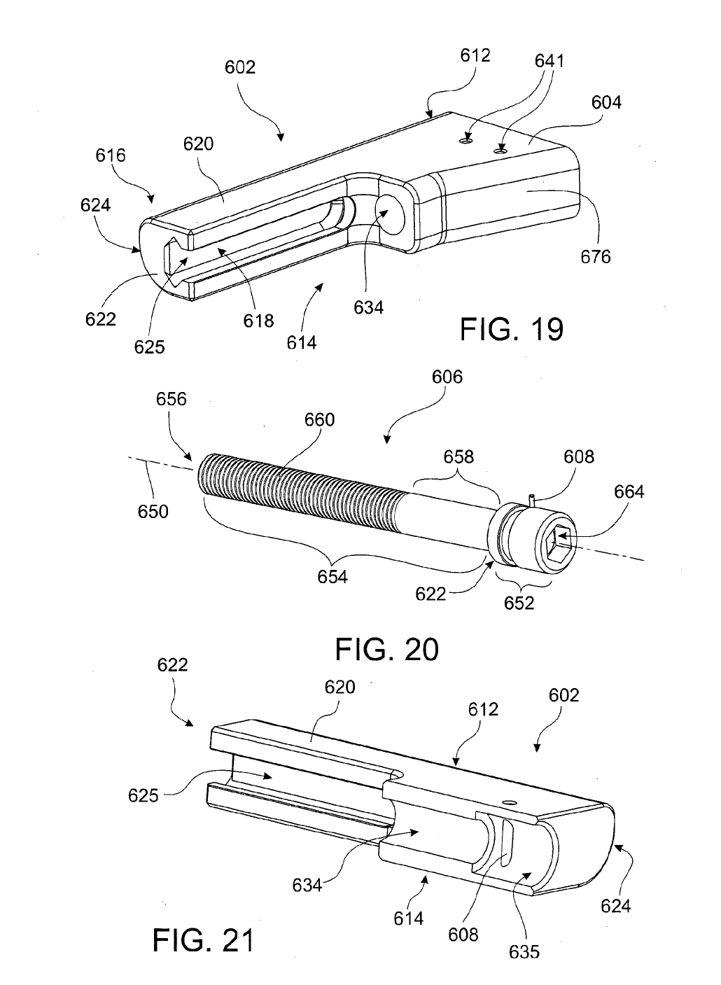

FIG. 19 shows a perspective view of the lock body 602. The lock body 602 has an upper side 612, an underside 614, a front end 616, a rear end 618, an arm 620 having a distal end 622 and a wedge formation 604. A forward facing adaptor bearing face 624 extends between the upper side 612 and the underside 614 at the front end 616. The adaptor bearing face 624 is configured to engage and bear against the lock bearing face 122 of the adaptor 100. As such, the adaptor bearing face 624 is the same as the adaptor bearing face 324 of the lock pin 300.

The arm 620 extends from the wedge formation 604. The wedge formation 604 is integrally formed with the arm 620. The arm 620 has an undercut groove 625 formed therein. The undercut groove 625 is the same as the undercut groove 325 of the arms 320 of the lock pin 300. The groove 625 originates at a distal end 622 and terminates short of the wedge formation 604.

The wedge formation 604 includes a bolt receiving through-hole 634 in which a shank part of the lock bolt 606 is captured. The through-hole 634 has a smooth bore such that the lock bolt 606 is rotatable in the hole 364. Keeper pin holes. 641 extend through the wedge formation 604 from the upper side 612 to the underside 614. The pin holes 641 pass through the bolt receiving bore 634. Part of the keeper pins 608 are located in the bore 634, as can be seen in the sectional view if FIG. 21.

The wedge formation 604 has an inwardly convergent tapered portion 676 at the rear end 618. The tapered portion 676 is the same as the tapered portions 376 of the wedge blocks 304, 305 of the lock pin 300.

FIG. 20 shows a perspective view of the lock bolt 606. The lock bolt 606 comprises a head 652 and a shank 654. The lock bolt 606 is a generally having a rotational axis 650. The shank 654 extends from the head 652 to a distal end 656. A section 658 of the shank 654 below the head 652 is smooth and the remaining section 660 of the shank 654 is screw-threaded.

The head 652 has a circumferential groove 662 in a sidewall thereof. The groove 662 receives the keeper pins 608 in a transverse direction to the rotational axis 650. One of the keeper pins 608 are shown in FIG. 20. The head 652 is cylindrical. The head 652 a socket 664 in the top for receiving a tip of a driving tool. The socket 664 is engageable by the driving tool to apply torque to the lock bolt 606 to rotate the lock bolt 306 about its rotational axis 650. The plugs 610 shown in FIG. 15 have keys 611 to be received in the socket 664 to locate the plug on the top of the head 652.

FIG. 21 shows a sectional perspective view of the lock body 602. The lock body 602 is sectioned along the through-hole 634. The through-hole 634 is counter-bored to provide a cylindrical counter-bore 635 in which the head 652 of the lock bolt 606 is rotatably received. The keeper pins 608 tansverse the counter-bore 635.

The keeper pins 608 capture the head 652 of the lock bolt 606 in the counter-bore 635. The keeper pins prevent the lock bolt 606 from being displaced in a direction along the rotation axis 650.

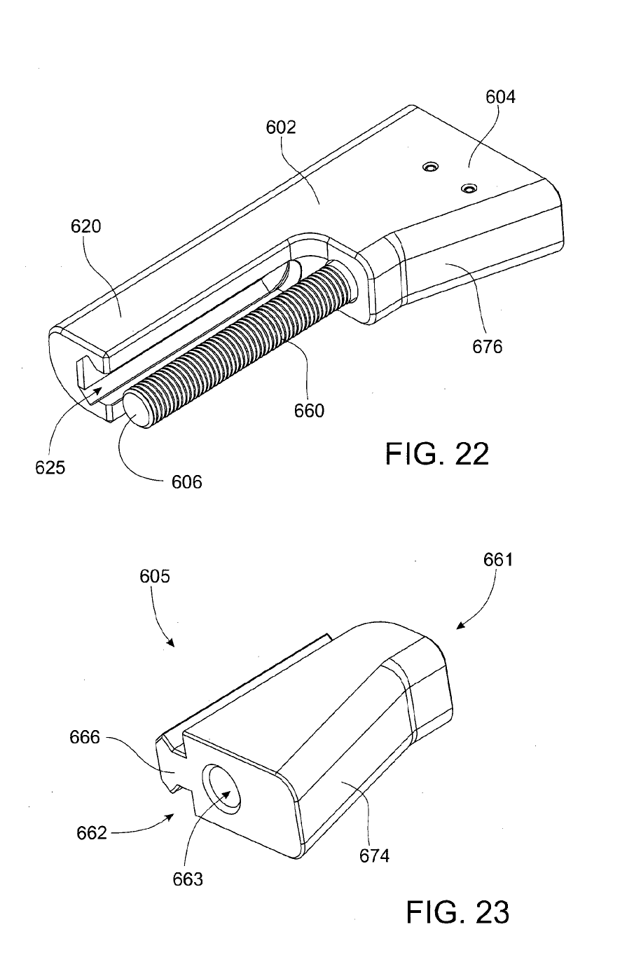

FIGS. 22 and 25 show different perspective views of the lock body 602 and the lock bolt 606 captured in the lock body 602. The screw threaded section 660 of the lock bolt 606 projects from the wedge formation 604. The screw-threaded section 660 is disposed parallel to the groove 625 in the arm 620. The head 652 of the lock bolt 606 is located in the counter-bore 635.

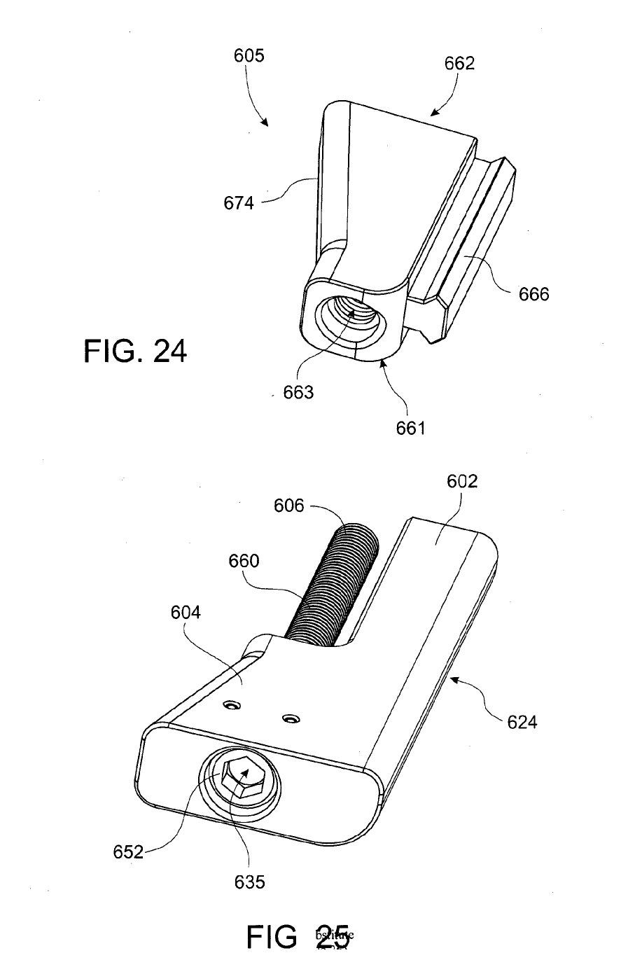

FIGS. 23 and 24 show different perspective views of the wedge block 605. The wedge block 605 is the same as the wedge block 305 described with reference to FIG. 9A-C. The wedge block 605 has a bore 663 which extends from an inner end 661 of the wedge block 605 to an outer end 662.

The bore 663 has an internal screw-thread 664 for screw threadingly engaging the lock bolt 606. The wedge block 305 has a key 666 which is receivable in the groove 625 of the lock body 602. The wedge block 605 has an inwardly convergent tapered portion 674 at an opposite side of the wedge block 605 to the key 666. The tapered portion 674 bears against one of the wedge bearing faces 236 of the tooth 200 as will be described in more detail.

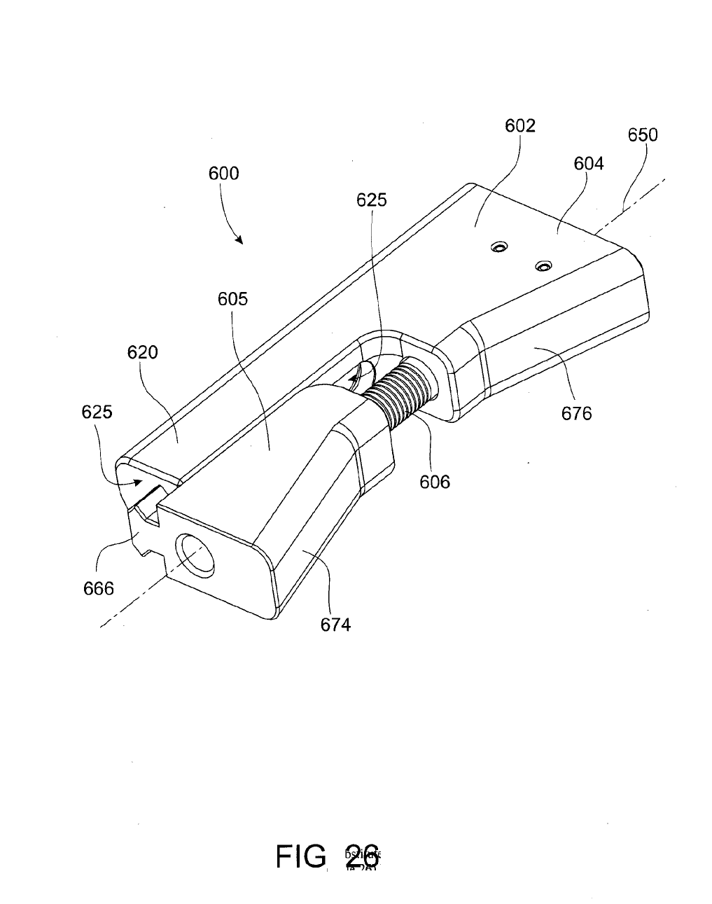

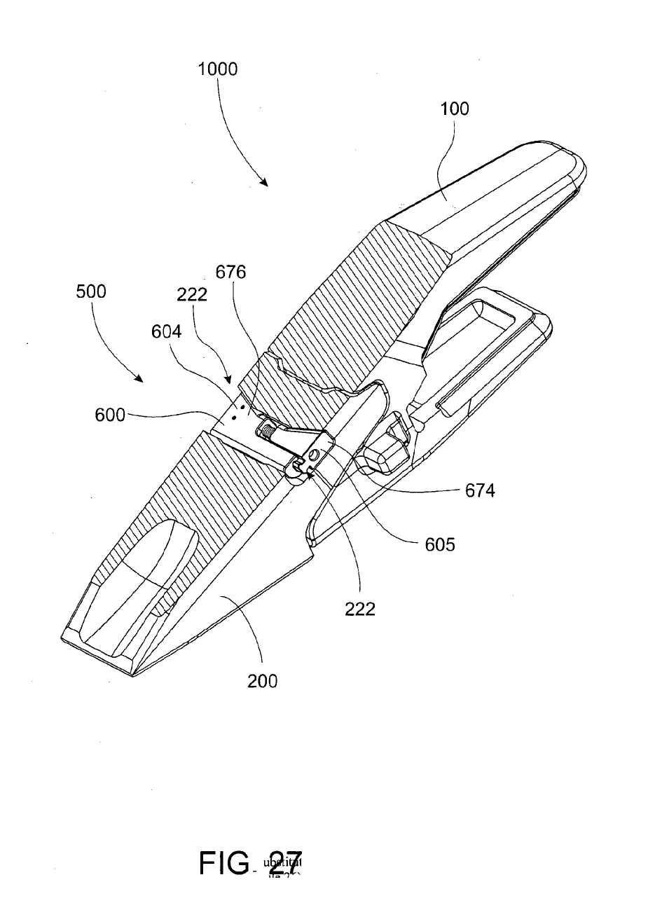

FIG. 26 shows a perspective view of the lock pin 600 in an assembled condition. The lock bolt 606 is rotatably captured in the lock body 602 as described with reference to FIGS. 22 and 25. The wedge block 605 is screw-threadingly received on screw-threaded section 660 of the lock bolt 606.

The key 666 of the wedge block 305 is received in the groove 625 of the arm 620. The key-in-groove retention of the key 666 in the groove 625 allows for displacement of the wedge block 605 along the rotational axis 650 of the lock bolt 606, but prevents dislocation of the wedge block 605 from the arm 620. The key-in-groove retention also prevents the wedge block 605 from rotation relative to the lock body 602. When the lock bolt 606 is rotated, in use, the wedge block 605 is urged either toward the wedge portion 604 or away from the wedge portion 604, depending on the direction of rotation of the lock bolt 606.

FIG. 27 shows the same perspective top sectional view of the excavator tooth assembly 1000 of FIG. 14, but with the lock pin 600 received in the passage 500. The wedge portion 604 and wedge block 605 of the lock pin 600 are captured in the apertures 222. The tapered portion 676 of the lock body 602 bears against one of the wedge bearing faces 236 of the tooth 200. The tapered portion 674 of the wedge block 605 bear against the other wedge bearing face 236 of the tooth 200. The wedge portion 604 and wedge block 605 exert pull-on forces on the wedge bearing faces 236 of the tooth 200. The pull forces are the same as the pull forces “P” shown in FIG. 16a. The adaptor bearing face 624 of the lock body 602 bears against the lock bearing face 122 of the adaptor 100 to counteract the pull-on force. The lock pin 600 is tightened by rotating the lock bolt 606 in a direction so that the wedge block 605 is forced toward the wedge portion 604 of the lock body 602.

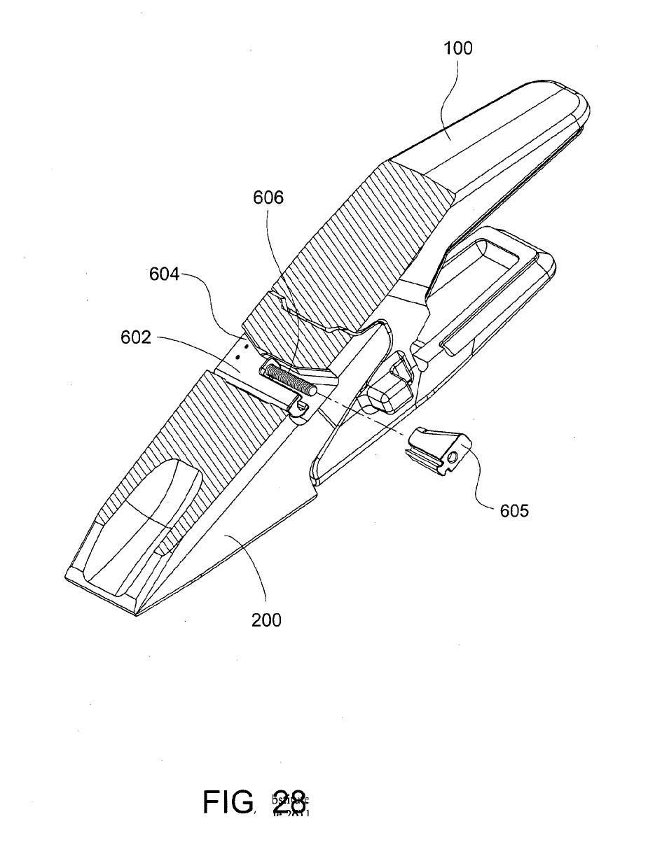

FIG. 28 shows the lock pin 600 mounted in the passage 500 of the excavator tooth assembly 1000, with the wedge block released from the lock bolt 606 to allow insertion or extraction of the lock body 602 from the passage 500. The lock body 602 is first introduced into the passage 500 from one end to a position wherein the wedge portion 604 abuts the wedge bearing face 236 of the tooth 200. The wedge block 605 is then introduced into the passage 500 from the opposite end to engage the lock bolt 606. The lock bolt 606 is rotated to displace the wedge block 605 to its position shown in FIG. 27. The lock pin 600 pulls the tooth 200 onto the adaptor 100 as the lock pin 600 is tightened.

Throughout the specification the aim has been to describe the invention without limiting the invention to any one embodiment or specific collection of features. Persons skilled in the relevant art may realize variations from the specific embodiments that will nonetheless fall within the scope of the invention. For example, whilst the invention has been described above with reference to mounting an tooth to an adaptor, other applications fall within the scope of the invention such as for mounting an adaptor body on an adaptor nose or a tooth to the adaptor body. Similarly, the adaptor may comprise an adaptor body and an adaptor nose.

It will be appreciated that various other changes and modifications may be made to the embodiment described without departing from the spirit and scope of the invention.

1. An excavator tooth assembly comprising:
a first wear member having a lock face;
a second wear member having a lock face, the second wear member releasably mountable on the first wear member;
wherein the lock face of the first wear member opposes the lock face of the second wear to define a lock passage therebetween when the second wear member is mounted on the first wear member.

2. The excavator tooth assembly of claim 1, wherein the second wear member includes aligned apertures, the aligned apertures being in register with opposite ends of the lock passage when the second wear member is mounted on the first wear member.

3. The excavator tooth assembly of claim 1, wherein the first wear member comprises a mounting nose having a projecting spigot and the second wear member has a socket which is complementary-shaped to the spigot to receive the spigot.

4. The excavator tooth assembly of claim 1, wherein the second wear member comprises spaced sidewalls in which the aligned apertures are formed.

5. The excavator tooth assembly of claim 4, wherein the sidewalls of the second wear member have rearwardly projecting ears and the first wear member has notches adapted to receive the ears.

6. The excavator tooth assembly of claim 4, wherein the first wear member has spaced channels adapted to receive lower edges of the sidewalls of the second wear member.

7. The excavator tooth assembly of claim 1, wherein the second wear member includes upper and lower walls converging from a rear end of the second wear member to a forward end of the second wear member.

8. The excavator tooth assembly of claim 7, wherein part of the upper wall of the second wear member comprises a roof having a roof face forming part of the lock face of the second wear member.

9. The excavator tooth assembly of claim 8, wherein the second wear member has a shoulder formation rearwardly spaced from a rearwardly facing socket opening of the second wear member, the shoulder formation having a forward facing shoulder face forming part of the lock face of the second wear member.

10. The excavator tooth assembly of claim 9, wherein the shoulder face is operatively downwardly extending from the roof face and wherein the shoulder face and roof face together form the lock face of the second wear member.

11. The excavator tooth assembly of claim 9, wherein the second wear member has one or more wedge bearing faces angled rearwardly from the shoulder face, the wedge bearing faces each extend into one of the aligned apertures in the sidewalls.

12. The excavator tooth assembly of claim 9, wherein the shoulder formation has a curved abutment face which abuts part of the lock face of the first wear member.

13. The excavator tooth assembly of claim 1, wherein the second wear member is an excavator digging tooth having a digging edge at a front end thereof.

14. The excavator tooth assembly of claim 1, wherein the first wear member has a curved saddle formation defining the lock face of the first wear member.

15. The excavator tooth assembly of claim 1, wherein the excavator tooth assembly includes a wear cap and the first wear member has a cap mounting formation for mounting the wear cap to the first wear member.

16. The excavator tooth assembly of claim 15, wherein the cap mounting formation has channels for slidably receiving rails of the wear cap to mount the wear cap to the first wear member.

17. The excavator tooth assembly of claim 16, wherein the excavator tooth assembly is adapted so that the wear cap is captured on the cap mounting formation by abutment with the second wear member.

18. The excavator tooth assembly of claim 1, wherein the lock passage is non-circular in cross section.

19. The excavator tooth assembly of claim 1, wherein the first wear member is an adaptor having a rear end region with spaced upper and lower walls between which a lip of a bucket or the like is receivable.

20. The excavator tooth assembly of claim 1, including a lock pin adapted to be received in the lock passage to releasably secure the second wear member to the first wear member.

21. The excavator tooth assembly of claim 2, including a lock pin which is adapted to be received in the lock passage to releasably secure the second wear member to the first wear member, the lock pin having opposite ends which are captured in the aligned apertures of the second wear member.

22. The excavator tooth assembly of claim 21, wherein the lock pin bears against a lock bearing face forming part of the lock face of the first wear member, and the lock pin bears against wedge bearing faces of the second wear member, the wedge bearing faces extending into the aligned apertures.

23. The excavator tooth assembly of claim 22, wherein the lock pin comprises a lock body bearing against the lock bearing face, and a wedge block bearing against the wedge bearing face, the wedge block displaceable relative to the lock body.

24. The excavator tooth assembly of claim 23, wherein the lock pin includes a lock bolt rotatably captured by the lock body, the wedge block engaged by the lock bolt to displace the wedge block relative to the lock body by rotation of the lock bolt.

25. The excavator tooth assembly of claim 21, wherein the lock body has a groove and the wedge block has a key receivable in the groove in a key-in-groove fit, the key displaceable along the groove as the wedge block is displaced relative to the lock body.

26. The excavator tooth assembly of claim 25, wherein the groove has an undercut face against which the key bears, thereby to capture the key in the groove.

27. A digging tooth having a digging edge at a front end thereof, the digging tooth including:
a socket with a rearwardly facing socket opening;
spaced sidewalls having aligned apertures; and
a shoulder formation extending between the apertures.

28. The digging tooth of claim 27, wherein the shoulder formation has a forward facing shoulder face.

29. The digging tooth of claim 28, wherein the shoulder face is rearwardly spaced from the socket opening.

30. The digging tooth of claim 28, wherein the digging tooth includes upper and lower walls converging from the socket opening to a forward end of the socket, wherein part of the upper wall comprises a roof having a roof face, the shoulder face extending operatively downwardly from the roof face.

31. The digging tooth of claim 30, wherein the shoulder face and roof face together form a lock face of the digging tooth.

32. The digging tooth of claim 28, wherein the digging tooth has one or more wedge bearing faces angled rearwardly from the shoulder face, the wedge bearing faces each extend into one of the aligned apertures in the sidewalls.

33. The digging tooth of claim 27, wherein the sidewalls have rearwardly projecting ears.

34. The digging tooth of claim 27, wherein the shoulder formation has a curved abutment face at a rear end of the digging tooth.

35. An adaptor of an excavator tooth assembly, the adaptor comprising:
a mounting nose having:
a forwardly projecting spigot; and
a lock face located rearwardly of the spigot, the lock face outwardly open along a substantial length of the lock face.

36. The adaptor of claim 35, wherein the adaptor includes notches adapted to receive ears of a digging tooth.

37. The adaptor of claim 35, wherein the adaptor has a curved saddle formation defining the lock face of the adaptor.

38. The adaptor of claim 35, wherein the adaptor has a cap mounting formation for mounting a wear cap to the adaptor.

39. The adaptor of claim 38, wherein the cap mounting formation has channels for slidably receiving rails of the wear cap.

40. The adaptor of claim 35, wherein the adaptor comprises an adaptor body and an adaptor nose.

41. A lock pin adapted to be received in a lock passage to releasably secure a first wear member to a second wear member, the lock pin comprising:
a lock body having an arm with a groove;
a wedge block having a key slideably received in the groove; and
a lock bolt rotatably captured in the lock body, the wedge block engaged by the lock bolt to displace the wedge block relative to the lock body as the lock bolt is rotated.

42. The lock pin of claim 41, wherein the groove has an undercut face against which the key bears, thereby to capture the key in the groove.

43. The lock pin of claim 41, wherein the lock bolt has a circumferential groove and the lock body includes a keeper formation seated in the groove to rotatably capture the lock bolt.

44. The lock pin of claim 41, wherein the lock bolt has a circumferential collar and the lock body has a race in which the collar is seated to rotatably capture the lock bolt.

45. The lock pin of any one of claims 41, wherein the wedge block has an internally threaded bore and the lock bolt has a screw thread which screw-threadingly engages the bore to displace the wedge block as the lock bolt is rotated.

46. The lock pin of claim 45, wherein the lock pin includes:
two wedge blocks, the internal screw threads of the different wedge blocks having different handedness;
the lock bolt having a screw thread of different handedness at opposite end regions of the lock bolt, the lock bolt including a central shank rotatably captured by the lock body;
the lock body having two arms, each of the arms having a groove for receiving one of the two wedge blocks;
wherein the wedge blocks are simultaneously displaced toward or away from each other depending on the rotational direction of the lock bolt.

47. The lock pin of claim 45, wherein the lock body has a wedge formation and a single arm, part of the lock bolt engaging the wedge block extending parallel to the groove in the arm.

48. The lock pin of claim 41, wherein the lock pin is non-circular in cross section.

49. A method of releasably securing a second wear member of an excavator tooth assembly to a first wear member of the excavator tooth assembly, the method including:
mounting the second wear member to the first wear member so that a lock face of the first wear member opposes a lock face of the second wear member to define a lock passage therebetween; and
inserting a lock pin into the lock passage, thereby to releasably secure the second wear member to the first wear member.

50. The method of claim 49, wherein the lock pin is tightened to pull the second wear member onto the first wear member by wedging engagement of the lock pin with the first wear member.
